(19) United States
(12) Patent Application Publication
(10) Pub. No.: US 2003/0187990 A1
(43) Pub. Date: Oct. 2, 2003

(54) Intelligent scheme for seamlessly maintaining communication sessions while switching devices

(76) Inventors: Robert C. Knauerhase, Portland, OR (US); Nikhil M. Deshpande, Beaverton, OR (US); Abhay A. Dharmadhikari, Beaverton, OR (US); Du V. Nguyen, Tigard, OR (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/112,437

(22) Filed: Mar. 29, 2002

(51) Int. Cl. G06F 15/16

(52) U.S. Cl. 709/227

(57) ABSTRACT

A method is described for maintaining a seamless communication session while switching devices. A user requests a communication session with a colleague device. The request for a communication session triggers a communication server to establish a first connection with the first device, and a second connection with the colleague device. When the user requests a switch from the first communication device to a second communication device, the request triggers the communication server to verify that the user of the second communication device is the same as the user of the first communication device. If the users are the same, then the communication server establishes a third connection with the second communication device, and then terminates the first connection with the first communication device. The second connection between the communication server and the colleague device is maintained such that entire process is transparent to the colleague.

### COPYRIGHT NOTICE

A portion of the disclosure of this patent document may contain material which is subject to copyright protection. To the extent that it does, the copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2002, Intel Corporation, All Rights Reserved.

### FIELD

Embodiments of this invention relate to the field of communication technologies, and more particularly, to a mechanism for switching communication devices without interruption of service.

### BACKGROUND

Various wireless and portable devices have enabled the transformation of a generation of sedentary lifestyles into a society of mobile professionals and homemakers alike. As the devices become more varied, the opportunities for communication in various situations and locations becomes more diversified.

The variety of communication devices, including personal computers (PC), laptops, personal digital assistants (PDA), and cell phones, enables users to communicate with each other through voice, text, instant messaging, or ink instant messaging, for example. The variety of devices also gives users different options for communicating, where choice of a communication device gives a user flexibility in terms of time, location, and mode of communication. For instance, a user can use a cell phone to make a call from the car, or use a laptop to write an email from the plane.

Under the current state of the art, users who switch communication devices must first terminate the communication session by terminating a connection with the first device, and establishing a connection with a second device. For instance, a user sitting at his desktop PC is chatting with a colleague. The user realizes that he has a meeting to go to, so he picks up his handheld PDA and prepares to leave. Under the current state of the art, he must first disconnect the chat session with his colleague, and then establish a new chat session from his PDA.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating an infrastructure in which embodiments of the invention may operate.

FIG. 2 is a block diagram illustrating a communication server.

FIG. 3 is a block diagram illustrating functionality in a communication server for seamlessly maintaining a communication session while switching devices.

FIG. 4 is a flowchart illustrating a method for seamless maintenance of a communication session while switching devices in accordance with general embodiments of the invention.

### DETAILED DESCRIPTION

In one aspect of embodiments of the invention is a method for seamlessly maintaining a communication session while switching devices. When a user on a first communication device wishes to establish a communication session with another user on another communication device (the other user and/or communication device hereinafter referred to as a colleague), a communication server is notified, and a first connection is established between the first device and the communication server, and a second connection is established between the communication server and the colleague device.

When the user wishes to switch from the first communication device to a second communication device for use in the communication session, the communication server establishes a third connection with the second communication device, and then terminates the first connection with the first communication device. Consequently, the second connection between the communication server and the colleague device is undisturbed, such that the communication session is maintained leaving the transition from the first communication device to the second communication device transparent to the colleague and colleague device.

Embodiments of the present invention include various operations, which will be described below. The operations associated with embodiments of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

Embodiments of the present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, embodiments of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Introduction

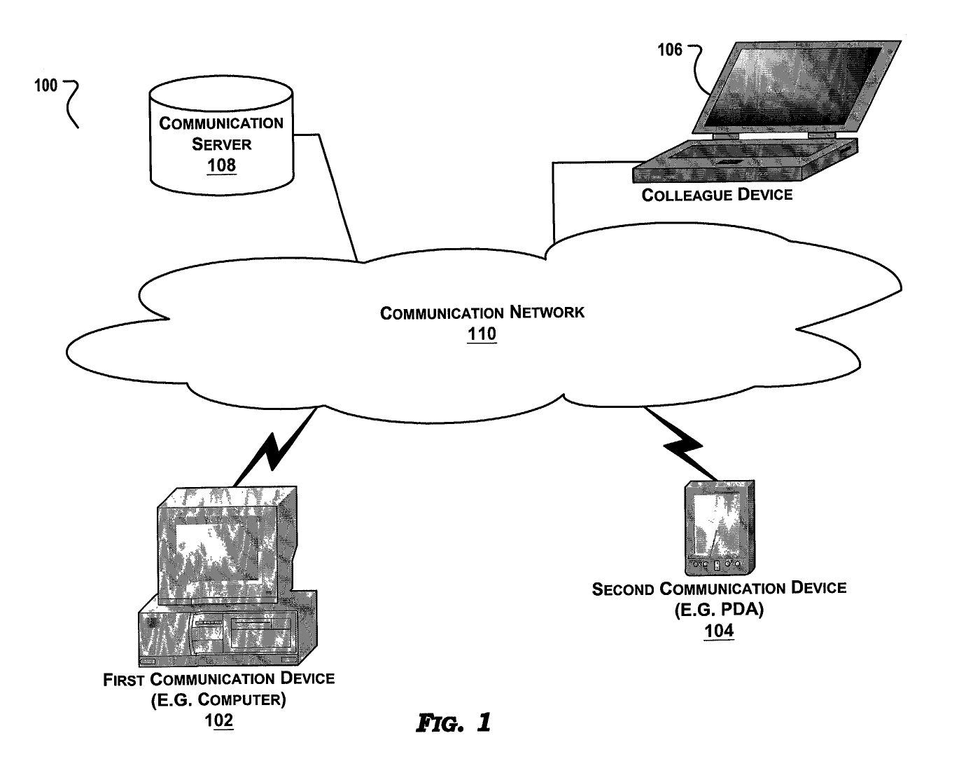

FIG. 1 is a block diagram illustrating an infrastructure 100 for seamless maintenance of communication sessions in accordance with embodiments of the invention. The infrastructure 100 comprises a first communication device 102; a second communication device 104; a colleague device 106; a communication server 108; and a communication network 110.

First communication device 102, second communication device 104, and colleague device 106 may each comprise any device for communicating voice and/or text data using various protocols, and over various communication networks 110. Devices include, but are not limited to, cell phones, personal digital assistants (PDA), and desktop PCs. Communication network 110 may comprise any type of network that enables first communication device 102, second communication device 104, and colleague device 106 to communicate with communication server 108. Communication network 110 may generally comprise any network such as the Internet, a cellular network, wireless Ethernet with or without a firewall, intranet; or any internetwork, including any combination of the above, for examples.

In embodiments of the invention, a user refers to one who uses a first communication device 102, and subsequently desires to switch to a second communication device 104, and a colleague refers to one that uses a colleague device 106 to communicate with a user on a first communication device 102 and a second communication device 104.

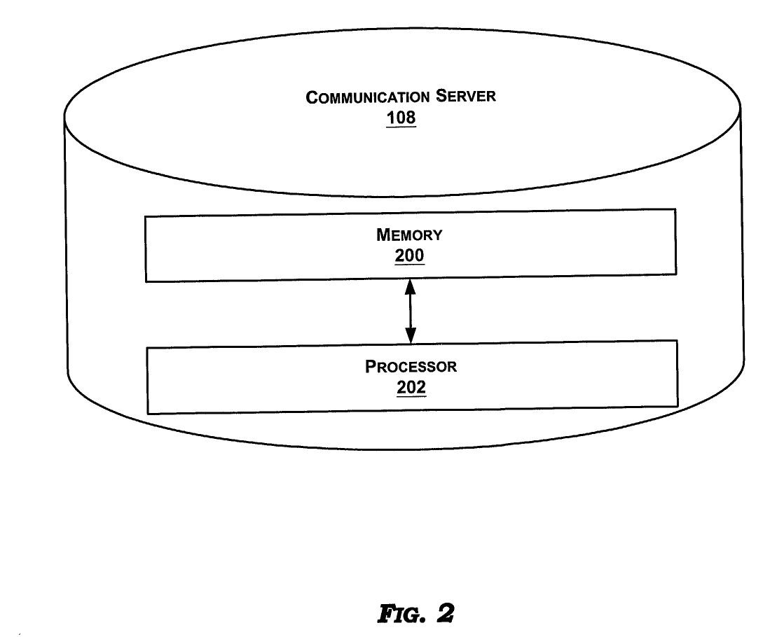

FIG. 2 is a block diagram illustrating a communication server. The communication server comprises a memory 200 for storing sequences of instructions for seamlessly maintaining a communication session while switching devices; and a processor to implement functionality for seamlessly maintaining a communication session while switching devices.

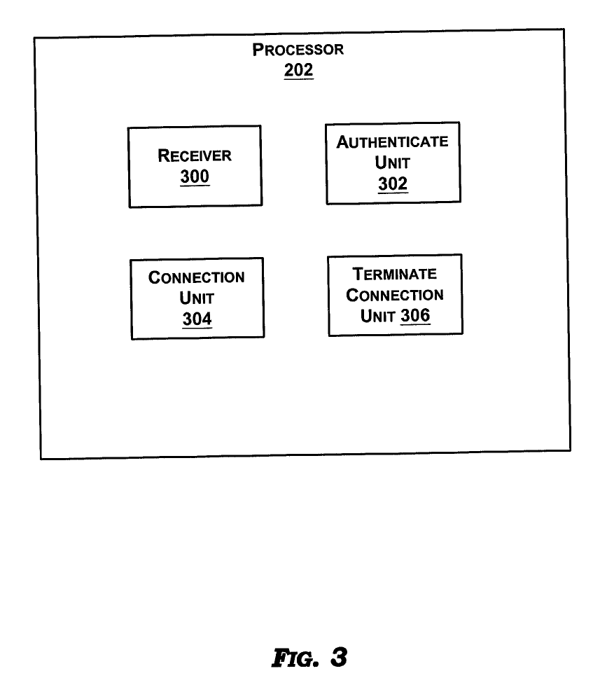

FIG. 3 is a block diagram illustrating a processor 202 of the communication 202 having functionality to implement seamless maintenance of a communication session while switching devices. The processor 202 comprises a receiver 300 to receive an indication to establish a communication session, and to receive a subsequent indication to switch devices while maintaining the communication session; an authentication unit 302 to authenticate that the user of the second communication device is the same user as the first communication device; a connection unit 304 to establish a first connection between the communication server 108 and the first communication device 102; a second connection between the communication server 108 and the colleague device; and a third connection between the second communication device 104; and a terminate connection unit 306 to terminate the first connection between the communication server 108 and the first communication device 102 upon establishing the third connection between the communication server 108 and the second communication device 104.

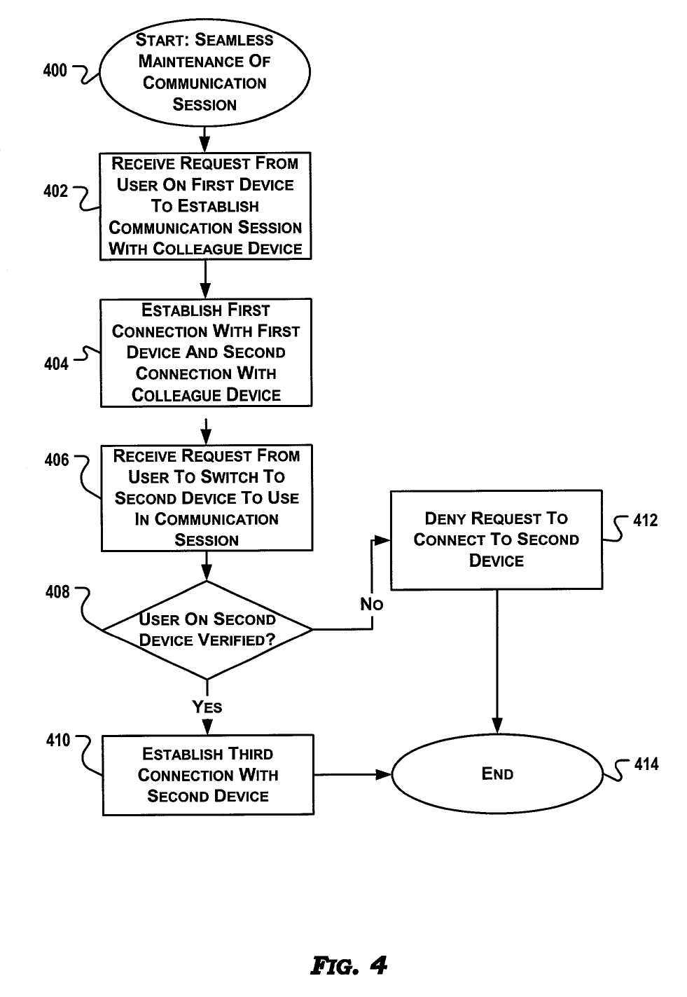

FIG. 4 is a flowchart illustrating a method for seamless maintenance of a communication session while switching devices in accordance with general embodiments of the invention. The method begins at block 400 and continues to block 402 where a request from a user on a first device to establish a communication session with a colleague device is received. At block 404, a first connection is established between the communication server and the first communication device, and a second connection is established between the communication server and the colleague device. At block 406, a request from the user to switch devices while maintaining the communication session is received. At block 408, user verification is determined. If the user is verified, then at block 410, a third connection is established between the communication server and the second communication device. If the user is not verified, then at block 412, the communication session denies the user's request to use the second communication device in the communication session. The method ends at block 414.

Establishing First and Second Connections

As used herein, when a user powers on a device, the device is enabled for communicating with another device. Once a device is powered on, the user may request a communication session with another device by, for example, calling the user of the colleague device, emailing the user of the colleague device, or sending an instant message, for examples. The request is routed through a communication server 108, and triggers the communication server 108 to establish a first connection with the first communication device, and then a second connection with the colleague device, where the first and second connections are physical connections.

Receiving Indication to Switch Devices

A user may indicate a desire to switch to a second communication device by selecting a particular device to switch to, or by a communication server 108 detecting a communication signal from a second communication device.

Embodiments of the invention are applicable when a user has multiple second communication devices that are always powered on, and the communication server detects a request to switch devices when a user selects one of the second communication devices (from the first communication device, for example); when the user requests verification from one of the second communication devices; or when the user selects a second communication device.

Embodiments of the invention are not to be limited to switching from a first communication device that is a different device than the second communication device. For example, if a user establishes a communication session using a communication device on a first connection that is a wireless connection with the communication server, and loses reception and/or the first connection drops due to poor reception, a second connection with the communication server may be established with the communication device (i.e., second communication device) when the reception improves. This may happen, for example, when a user is driving through a tunnel. In this embodiment, the first connection is terminated prior to establishing the second connection, and the first communication device is the same as the second communication device.

### User Selects Second Communication Device

In one embodiment, a user may specify a device to switch to. A selection may be accomplished by selecting the second communication device 104 from a menu on the first communication device 102, or by using voice recognition technology, for example.

### User Uses Second User Device

In another embodiment, the second communication device may be detected by a communication signal. In this embodiment, a user powers on a second communication device and implicitly or explicitly requests verification for this new connection while maintaining the communication session.

Establishing a Third Connection

When a request to switch devices is received, the communication server 108 verifies if the user of the second communication device is the same as the user of the first communication device. If a user is verified, then the third connection is established. Depending upon the circumstances and/or policies of the communication server, the first connection may be terminated (such as when a user switches from a desktop to a laptop) or maintained (such as when a user switches from a desktop to a handheld, and wishes to maintain the desktop connection for its keyboard capabilities).

Examples are provided and explained below. As one of ordinary skill in the art would understand, however, this list is intended to be for illustrative purposes only, and is not intended to be an exhaustive list. Furthermore, as one of ordinary skill in the art would understand, when a user is verified, the integrity of the verification is only as foolproof as the integrity of the user allows. Thus, if user information entered from the second communication device is correct (i.e., the information corresponds to the user), then the user is verified. However, if an unauthorized user enters the same information from the second communication device, then the user is still verified because the information entered for the particular user is correct. While embodiments of the invention do not address issues of integrity, embodiments of the invention may be used in conjunction with systems and technologies that do address the issue.

### Authentication

A user on a second communication device is verified if the user on the second communication device can be authenticated to the communication server 108.

Cryptographic authentication can be accomplished with digital signatures with sufficiently strong cryptographic methods, or cryptographic digital certificates, for example. In this embodiment, a user may switch to a second device 104 without specifying a particular second communication device. A user in this embodiment would power on a second communication device, and log in to the communication server 108 with the user's authentication information. If the user is authenticated, then the user is verified to be the same user as the first communication device.

In one embodiment, pre-registration authentication may be used where a user of a second communication device is verified if the second communication device can be uniquely identified, and has been registered as a communication device corresponding to the user of the first communication device. In this embodiment, a user pre-registers known communication devices (i.e., including first communication device 102 and second communication device 104) with a communication server 108 so that the communication server 108 will recognize a user's selection of a device. A communication device can be registered by submitting, for example, a network address of a device such as a desktop (i.e., static IP (Internet Protocol) address); or a phone number or serial number of a device such as a cell phone. For example, if a user selects a second communication device, and the second communication device has been pre-registered, then the user may be automatically verified when the second communication device is then powered on.

In authentication using a unique number, a user may be verified by contacting the communication server 108 via a unique number. In this embodiment, the communication server 108 has a plurality of addresses, where each address corresponds to a unique number such that when the communication server 108 receives a signal from a given address, the communication server 108 can determine who the user is from the unique number that is used to connect to the server using the given address. If the user is the same as the user on the first communication device, then the user is verified.

In yet another embodiment of the invention, pin authentication allows a user to be verified by entering a pin number from the second device. If the pin number corresponds to the user of the first communication device 102, then the user is verified.

In embodiments where a user may select a device by voice, authentication may be accomplished using voice recognition technology, where the user is verified if the user on the second communication device 104 is recognized to be that of the user on the first communication device 102.

### Intent To Use at Predetermined Time

In another embodiment of the invention, a user of a second communication device is verified if the second communication device has been designated as the communication device that will be used at some predetermined time. In this embodiment, a user powers on the specified second communication device at a specified time. The specified time may comprise a particular time, such as “12:30 P.M. PST” (with margin for error), a window of time, such as “between 12:00 P.M. PST and 1:00 P.M. PST”, or “within 5 minutes from now”.

For example, if a user selects a second communication device, and the second communication device has been designated for use at 12:00 P.M. PST, then the user may be automatically verified when the second communication device is then powered on at 12:00 P.M. PST. Or, if the user specifies that a second communication device 104 will be used “within 5 minutes from now”, and the user selects the second communication device 104 within 3 minutes, the user is automatically verified at that time.

Exemplary Embodiment

An example is provided in accordance with embodiments of the invention as described above. A user at a desktop (first communication device) requests to connect to a colleague (on a desktop). Communication server establishes a first connection with the desktop, and a second connection with the colleague. The user types text messages to the colleague on the desktop. At some later time, the user is called away as he exchanges text with the colleague on the desktop. Rather than end the connection, the user picks up his handheld (second communication device), and dials a unique number (authentication using unique number) to request verification. The communication server verifies the user of the second communication device, and establishes a third connection with the second communication device. In this example, the first connection is then terminated. The process of switching from the first communication device to the second communication device is transparent—the colleague is unaware that a switch has taken place.

Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising:
establishing a communication session between a user on a first communication device and a colleague on a colleague device by establishing a first connection between the first communication device and a communication server, and a second connection between the communication server and the colleague device;
receiving a request from the user to switch from the first communication device to a second communication device for the communication session;
verifying the user of the second communication device; and
if the user is verified, then maintaining the communication session by establishing a third connection between the second communication device and the communication server.

2. The method of claim 1, additionally comprising terminating the first connection after establishing the third connection.

3. The method of claim 1, wherein said receiving the request to switch devices comprises receiving a selection of the second communication device, and establishing the third connection comprises verifying that the second communication device has been pre-registered with the communication server, and if the second communication device has been pre-registered, then making the connection between the second communication device and the communication server.

4. The method of claim 1, wherein the communication server includes a plurality of addresses for receiving communications from devices, and:
said receiving the request to switch devices comprises receiving a signal corresponding to one of the addresses; and
said establishing the third connection comprises answering the signal.

5. The method of claim 1, wherein said receiving the request to switch devices comprises receiving an authentication request from the second device, and said establishing the third connection comprises authenticating a user of the second device, and if the user is authenticated, then making a connection between the second device and the communication server.

6. The method of claim 1, wherein said receiving the request to switch devices comprises receiving an intent to switch to the second device at a specified time, and establishing the third connection comprises detecting the second device at the specified time.

7. The method of claim 1, wherein the first communication device and the second communication device are the same devices.

8. An apparatus comprising:
a receiver to receive an indication to establish a communication session between a first communication device and a colleague device, and to subsequently receive an indication to seamlessly switch from the first communication device to the second communication device to use in the communication session;
an authenticator unit to verify that the user of the second communication device is the same user as the first communication device; and
a connection unit to establish a first connection and a second connection to enable communication between the first communication device and the colleague device, and to subsequently establish a third connection to enable communication between the second communication device and the colleague device.

9. The apparatus of claim 8, additionally comprising a terminate connection unit to terminate the first connection after establishing the third connection.

10. The apparatus of claim 8, wherein the connection unit establishes:
the first connection by connecting the first communication device;
the second connection by connecting the colleague device; and
the third connection by connecting the second communication device.

11. The apparatus of claim 8, wherein the authenticator unit verifies that the user of the second communication device is the same user as the first communication device by authenticating a user of the second communication device.

12. The apparatus of claim 8, wherein the authenticator unit verifies that the user of the second communication device is the same user as the first communication device by receiving a request to connect the second communication device at a specified time.

13. A system comprising:
a memory to store sequences of instructions that enable seamless maintenance of communication sessions while switching devices;
a bus communicatively coupled to the memory to transport the sequences of instructions to a processor; and
the processor communicatively coupled to the bus to process the instructions, and to:
receive an indication to establish a communication session to exchange text data between a first communication device and a colleague device, and to subsequently receive an indication to seamlessly switch from the first communication device to the second communication device to use in the communication session;
verify that the user of the second communication device is the same user as the first communication device; and
establish a first connection and a second connection to enable communication between the first communication device and the colleague device, and to subsequently establish a third connection to enable communication between the second communication device and the colleague device.

14. The system of claim 13, the processor to additionally terminate the first connection after establishing the third connection.

15. The system of claim 13, wherein the processor verifies that the user of the second communication device is the same user as the first communication device by verifying that the second communication device has been pre-registered with the communication server.

16. The system of claim 13, wherein the processor verifies that the user of the second communication device is the same user as the first communication device by receiving a signal corresponding to an address that is known to correspond to the user.

17. A machine-readable medium having stored thereon data representing sequences of instructions, the sequences of instructions which, when executed by a processor, cause the processor to perform the following:
establish a communication session between a user on a first communication device and a colleague on a colleague device by establishing a first connection between the first communication device and a communication server, and a second connection between the communication server and the colleague device;
receive a request from the user to switch from the first communication device to a second communication device for the communication session;
verify the user of the second communication device; and
if the user is verified, then maintain the communication session by establishing a third connection between the second communication device and the communication server.

18. The machine-readable medium of claim 17, wherein said receiving the request to switch devices comprises receiving a selection of the second communication device, and establishing the third connection comprises verifying that the second communication device has been pre-registered with the communication server, and if the second communication device has been pre-registered, then making the connection between the second communication device and the communication server.

19. The machine-readable medium of claim 17, wherein the communication server includes a plurality of addresses for receiving communications from devices, and:
said receiving the request to switch devices comprises receiving a signal corresponding to one of the addresses; and
said establishing the third connection comprises answering the signal.

20. The machine-readable medium of claim 17, wherein said receiving the request to switch devices comprises receiving an authentication request from the second device, and said establishing the third connection comprises authenticating the second device, and if the second device is authenticated, then making a connection between the second device and the communication server.

21. An apparatus comprising:
at least one processor
a machine-readable medium having instructions encoded thereon, which when executed by the processor, are capable of directing the processor to:
establish a communication session between a user on a first communication device and a colleague on a colleague device by establishing a first connection between the first communication device and a communication server, and a second connection between the communication server and the colleague device;
receive a request from the user to switch from the first communication device to a second communication device for the communication session;
verify the user of the second communication device; and
if the user is verified, then maintain the communication session by establishing a third connection between the second communication device and the communication server.

22. The apparatus of claim 21, wherein the processor receives a request from the user to switch from the first communication device to a second communication device for the communication session by receiving a selection of a second communication device to use.

23. The apparatus of claim 22, wherein the processor verifies the user of the second communication device by determining that the selected communication device has been powered on.

24. An apparatus comprising:
means for receiving an indication to establish a communication session between a first communication device and a colleague device, and means for subsequently receiving an indication to seamlessly switch from the first communication device to the second communication device to use in the communication session;
means for verifying that the user of the second communication device is the same user as the first communication device; and
means for establishing a first connection and a second connection to enable communication between the first communication device and the colleague device, and to subsequently establish a third connection to enable communication between the second communication device and the colleague device.

25. The apparatus of claim 24, additionally comprising means for terminating the first connection after establishing the third connection.

26. The apparatus of claim 24, wherein said means for subsequently receiving an indication to seamlessly switch from the first communication device to the second communication device to use in the communication session comprises means for receiving authentication information from a second communication device.

27. The apparatus of claim 26, wherein said means for verifying that the user of the second communication device is the same user as the first communication device comprises means for authenticating a user of the second communication device.
